(19) United States
(12) Patent Application Publication
(10) Pub. No.: US 2012/0113102 A1
(43) Pub. Date: May 10, 2012

(54) 3D-IMAGE CONTROL APPARATUS AND METHOD

(75) Inventors: Kazuyuki Sato, Yokohama-shi (JP); Yuzo Sato, Hachioji-shi (JP)

(73) Assignee: CANON KABUSHIKI KAISHA, Tokyo (JP)

(21) Appl. No.: 13/286,039

(22) Filed: Oct. 31, 2011

(30) Foreign Application Priority Data
Nov. 9, 2010 (JP) 2010-251158

(51) Int. Cl. G06T 15/00

(52) U.S. Cl. 345/419

(57) ABSTRACT

According to an aspect of the present invention, an apparatus which enables viewing of a 3D image, by controlling an impulse-type image to alternately display a left-eye image and a right-eye image in a time-division manner, and by alternately opening/closing a left shutter and a right shutter of shutter eyeglasses in synchronism with switch between the left-eye image and the right-eye image, and the apparatus includes an input unit configured to input an image signal for displaying an image as a 3D-image, and an image processing unit configured to generate a luminance signal for displaying the right-eye image and the left-eye image from the image signal, and outputs the signal to the image display, and the apparatus further includes a control unit configured to control the image processing unit to display a same image in the first sub-frame and the second sub-frame.

### BACKGROUND OF THE INVENTION

1. Field of the Invention

The present invention relates to a 3D-image control apparatus and its method, for enabling viewing of an image displayed as 3D images.

2. Description of the Related Art

A well-known 3D image viewing system enables viewing of 3D images. In this system, a right-eye image (for right eye) and a left-eye image (for left eye) are alternately displayed in a time-division manner using an image display apparatus. The 3D images are viewed through shutter eyeglasses whose left/right shutters alternately open and close in synchronism with the switch between the right/left-eye images.

Japanese Patent Application Laid-Open No. 2009-31523 discusses a 3D image display apparatus. This apparatus alternately displays a right-eye image and a left-eye image for every two frames, thereby inhibiting crosstalk which occurs when the frame rate is increased.

Descriptions will now be made to an issue when a 3D image displayed by the impulse-type image display is three-dimensionally viewed as an observation image through liquid crystal shutter eyeglasses. The impulse-type image display is a display apparatus for forming images with a system in which lighting up and off of pixels completes in an address period. Specifically, in this apparatus, the luminance of lighting pixels in the address period (selective period) is not held over one frame. The luminance of light-off pixels converges to zero, in a predetermined afterglow period based on afterglow characteristics of a luminous member, such as phosphor. Typical impulse-type image displays are a cathode ray tube (CRT), a field emission type electron emitting display.

FIGS. 9A and 9B illustrate the relationship between the display periods of images formed by a line-sequential drive and the shutter open/close timings of shutters of liquid crystal eyeglasses. Suppose that the frame frequency is 120 Hz. A left-eye image (left frame) and a right-eye image (right frame) are alternately displayed on every frame. The left and right shutters of the liquid crystal shutter eyeglasses open and close in synchronism with the left/right frames.

In a normally-white mode, in the liquid crystal shutter eyeglasses, a response time (rise time) from “close” to “open” is slower than a response time (decay time) from “open” to “close”, and are respectively about 2.5 ms and 500 μsec.

If it is intended that the rise time and the decay time of the shutter are set both within a vertical blanking period (hereinafter referred to as a blanking period) of images, the blanking period occupies one fourth or greater of the vertical scanning period. As a result, the horizontal scanning period will be short. Thus, when gradation display is made by pulse-width modulation, the display luminance decreases, and also the dynamic range is narrowed.

As illustrated in FIG. 9B, if the vertical blanking period is set equal to the rise time of the shutter, a “2 msec” part of the rise time of the shutter gets into an image display period. As a result, the shutter transmittance decreases by 30% at most in the display device with 1080 scanning lines . Thus, in an observation image, as illustrated in FIG. 9C, a belt-like dark part is generated in an area corresponding to 280 lines on the top of the screen.

Such luminance differences occur in a screen of the observation image in a conventional 3D image viewing system that includes an impulse-type image display and a liquid crystal shutter eyeglasses.

### SUMMARY OF THE INVENTION

According to an aspect of the present invention, an apparatus which enables viewing of a 3D image, by controlling an impulse-type image display to alternately display a left-eye image and a right-eye image in a time-division manner, and by alternately opening/closing a left shutter and a right shutter of shutter eyeglasses in synchronism with switch between the left-eye image and the right-eye image, and the apparatus includes an input unit configured to input an image signal for displaying an image as the 3D-image, and a processing unit configured to generate a luminance signal for displaying the right-eye image and the left-eye image from the image signal, and outputs the luminance signal to the image display, wherein the image display sequentially selects a scanning line to form an image on a screen, in a predetermined frame period, and wherein each frame for displaying the right-eye image and the left-eye image includes a first sub-frame with a first frame period and a second sub-frame with a second frame period that is longer than the first frame period.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is an explanatory diagram for explaining reading timings of image signals, according to the present invention.

FIGS. 2A to 2C are block diagrams of a 3D-image viewing system, according to the present invention.

FIGS. 3A and 3B are timing charts each illustrating waveforms of driving pulses, according to the present invention.

FIG. 4 is a flowchart of operations in a first exemplary embodiment of the present invention.

FIGS. 5A to 5C are explanatory diagrams each illustrating the relationship between a vertical line counter value and a correction value or luminance.

FIG. 6 is a timing chart illustrating other waveforms of driving pulses, according to the present invention.

FIG. 7 is a flowchart of operations in a second exemplary embodiment of the present invention.

FIG. 8 is a flowchart of operations in another exemplary embodiment of the present invention.

FIGS. 9A to 9C are explanatory diagrams for explaining the subjects of the present invention.

FIG. 10 is an explanatory diagram for explaining a method of setting the frame rate, according to the present invention.

### DESCRIPTION OF THE EMBODIMENTS

Various exemplary embodiments, features, and aspects of the invention will be described in detail below with reference to the drawings.

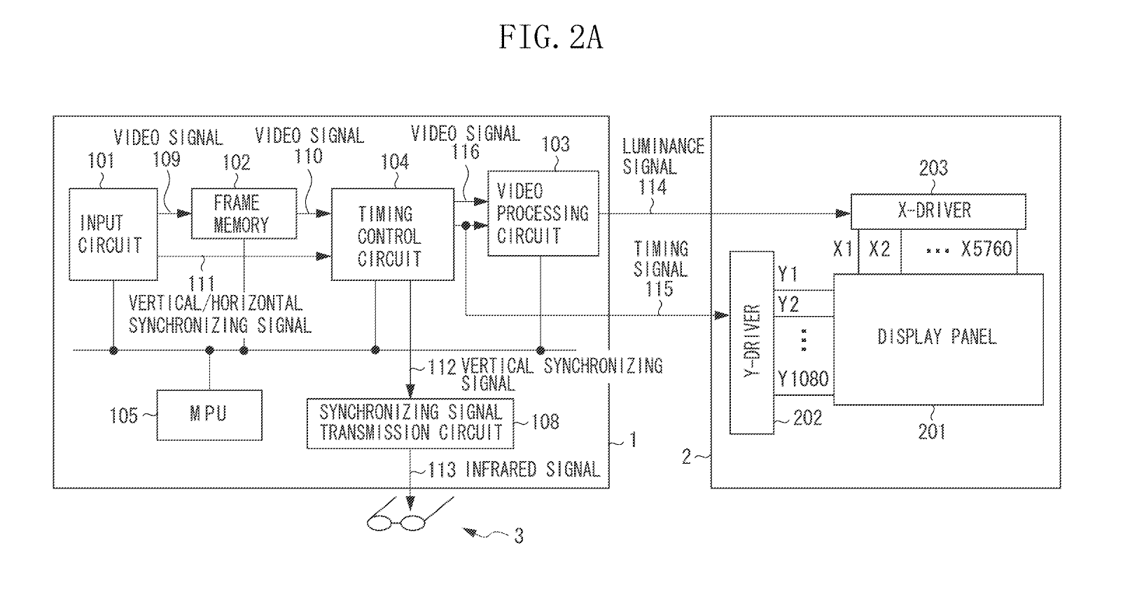

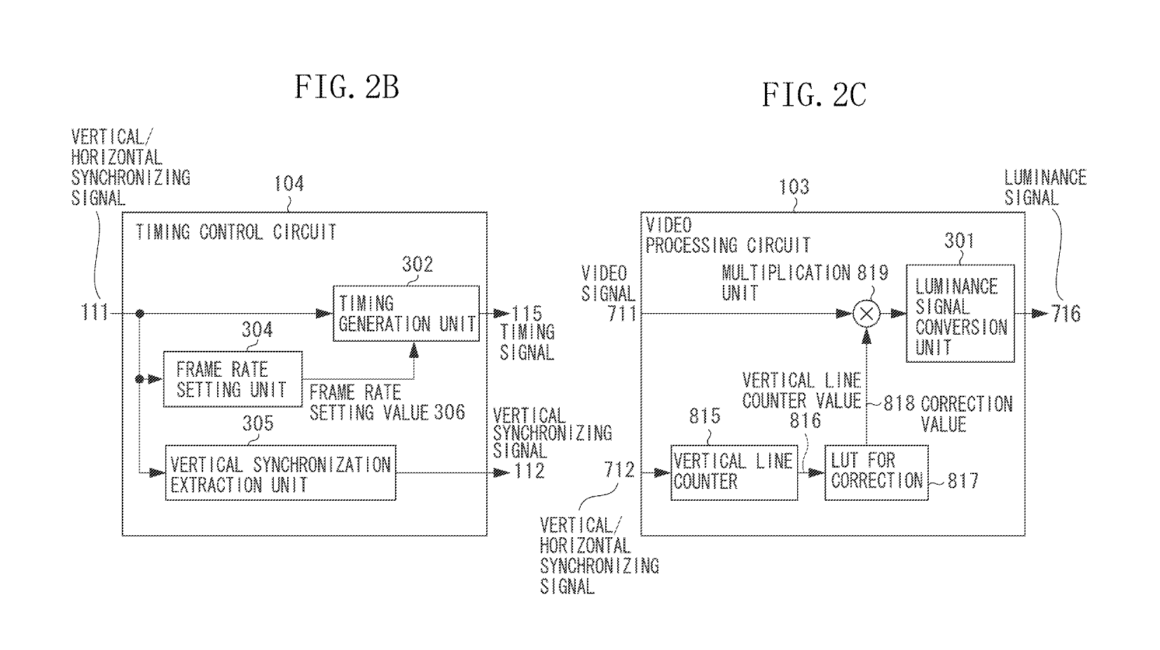

A first exemplary embodiment will now be described. FIG. 2A is a block diagram of a 3D-image viewing system according to the present invention. The system includes a 3D-image control apparatus 1, a display device 2, and liquid crystal shutter eyeglasses 3.

The display device 2 is an impulse-type image display, and includes a surface-conduction electron-emitter display panel (hereinafter referred to as a display panel) 201, an X-driver 203 and a Y-driver 202 for driving the display panel 201. The configuration and manufacturing method of the display panel 201 are discussed in detail in Japanese Patent Application Laid-Open No. 2000-250463. The display panel 201 includes pixels (1920×3×1080) that are arranged in a matrix form including a plurality of vertical lines (scanning lines) and a plurality of horizontal lines (signal lines). The display panel 201 is driven according to a line-sequential system. In this system, vertical lines are sequentially selected downward from the top of the screen in a predetermined frame period, thereby forming an image on the screen. The frame rate (refresh rate) is 120 Hz (frame period: 8.3 msec). One frame is divided into a sub-frame at a frame rate of 500 Hz (frame period: 2 msec) and a sub-frame at a frame rate 172 Hz (frame period: 5.8 msec). The 3D-image is formed by two frames of a right frame and a left frame.

The 3D-image control apparatus 1 includes the following configuration. A micro processing unit (MPU) (control unit) 105 controls each of the blocks cooperatively. An input circuit 101 inputs a 3D image from an input source, and outputs an image signal and vertical/horizontal synchronizing signals. The input source includes the digital TV broadcast, a video contents distribution system through the Internet, a game console, and a video player. The input circuit 101 includes a digital tuner and an input interface. The image signals include a right-eye image signal and a left-eye image signal, having a resolution (1920×1080), and both image signals are switched from each other at 120 Hz on every frame.

A frame memory (memory unit) 102 stores the image signal of one frame output from the input circuit 101.

A timing control circuit 104 is synchronized with a horizontal synchronizing signal in response to an instruction from the MPU 105, and reads out an image signal from the frame memory 102. A video processing circuit 103 converts the image signal read from the frame memory 102 into a luminance signal corresponding to the specifications of the display device 2, and outputs the signal to the X-driver 203. Further, the timing control circuit 104 outputs a timing signal for controlling a horizontal scanning period (1H) and a vertical scanning period (1V) to the Y-driver 202, in response to a vertical/horizontal synchronizing signal and/or an instruction from the MPU 105.

The X-driver (modulation driver) 203 generates a signal pulse corresponding to the luminance level based on the luminance signal, and pulse width modulation (PWM)-drives the display panel 201.

The Y-driver (scanning driver) 202 includes an output unit with 1080 channels, and outputs scanning pulses sequentially to the vertical lines of the display panel 201, based on a timing signal.

A synchronizing signal transmission circuit 108 sends an infrared signal for controlling opening/closing of a right/left shutter of the liquid crystal shutter eyeglasses 3 through infrared communication, based on a vertical synchronizing signal output from the timing control circuit 104.

The liquid crystal shutter eyeglasses 3 receive the infrared signal, and open/close the right/left shutter in synchronism with switching of the left/right image signals. The liquid crystal shutter opens/closes according to a normally-white mode, and can also open/close according to a normally-black mode. In the normally-black mode, the relationship between the rising and decay of the liquid crystal shutter will be opposite to the normally-white mode.

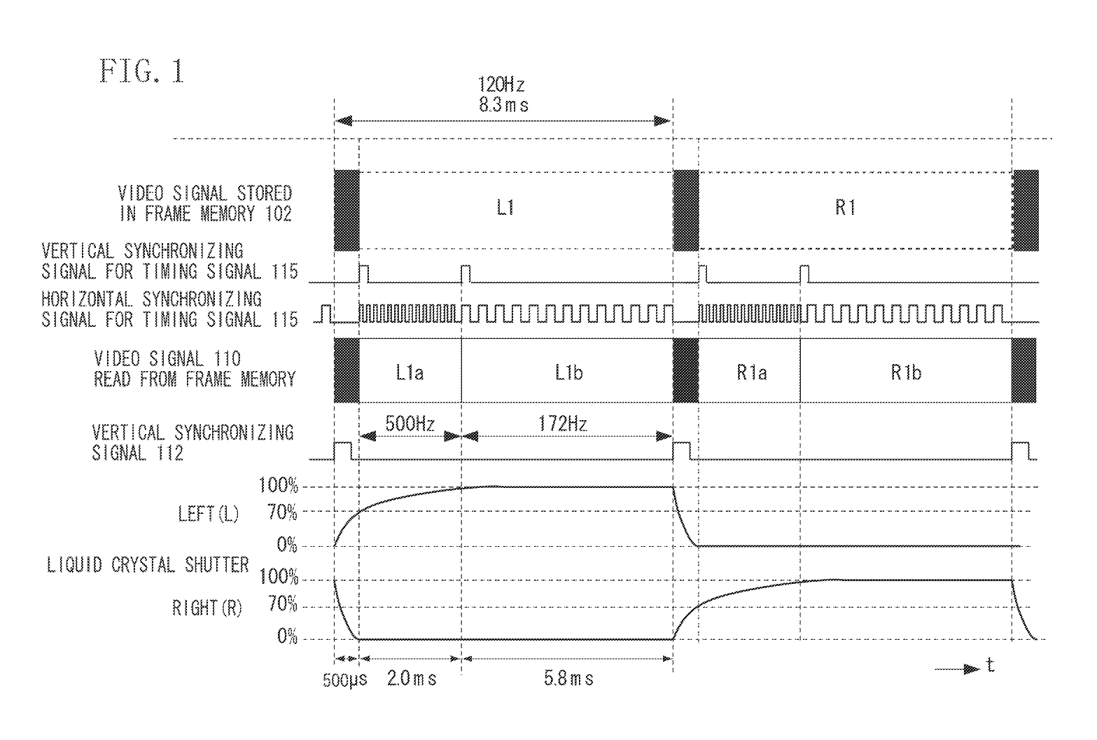

FIG. 1 illustrates the relationship between the image signal and the opening/closing timings of the liquid crystal shutter eyeglasses 3. The image signal is read from the frame memory 102 of the 3D-image viewing system according to the present invention. The frame memory 102 stores left and right image signals (L1, R1, L2, R2 . . . ) alternately. The same image signal is read out twice from the frame memory 102. The frame L1 (left frame) includes a sub-frame L1a (first sub-frame) at a frame frequency of 500 Hz (first frame period) and a sub-frame L1b (second sub-frame) at a frame frequency of 172 Hz (second frame period). The same left-eye image is displayed twice in each sub-frame at different frame frequencies. The frame frequency of each sub-frame is determined according to the rising characteristics of the liquid crystal shutter. Specifically, the frame period of the sub-frame L1a (L1a sub-frame period) is set to display the L1a image in the rise time (2.0 ms) of the left shutter. The frame period of the sub-frame L1b is set to display the L1b image in a period (5.8 ms) after complete rising of the left shutter. The frame period of the frame L1 includes a frame period L1a, a frame period L1b, and a vertical blanking period. Thus, the frame period L1b corresponds to a resultant period obtained by subtracting the frame period L1a and the vertical blanking period from the frame period L1. The frame R1 (right frame) is divided into a sub-frame R1a and a sub-frame R1b, and frame frequencies are set for the sub-frames.

The left/right shutters of the liquid crystal shutter eyeglasses 3 open and close in synchronism with a vertical synchronizing signal that is synchronized with the left frame period (period including both the sub-frame L1a and the sub-frame L1b) and the right frame period (period including both the sub-frame R1a and the sub-frame R1b). In the present exemplary embodiment, the decay time of the shutter is set within the blanking period (0.5 msec). However, if the liquid crystal shutter is used in the normally-black mode, the rise time is set within the blanking period.

FIG. 2B is a block diagram of the timing control circuit 104. A frame rate setting unit 304 receives a vertical/horizontal synchronizing signal, and outputs a frame rate setting value corresponding to the vertical lines to a timing generation unit 302. Because the response characteristics of the shutter of the liquid crystal shutter eyeglasses 3 are specified in advance, a frame rate setting value corresponding to the vertical/horizontal synchronizing signal is stored in a memory in the frame rate setting unit 304. The timing generation unit 302 outputs a timing signal which has been generated by modulating the vertical/horizontal synchronizing signal to the Y-driver, based on the frame rate setting value. A vertical synchronization extraction unit 305 extracts a vertical synchronizing signal from the vertical/horizontal synchronizing signal, and outputs the signal to the synchronizing signal transmission circuit 108. The MPU 105 controls the memory 102 and the timing control circuit 104 to cooperatively and sequentially read out image signals corresponding to one frame from the memory 102 at different frame rates and to output the read signals to the video processing circuit 103, in synchronism with the timing signal.

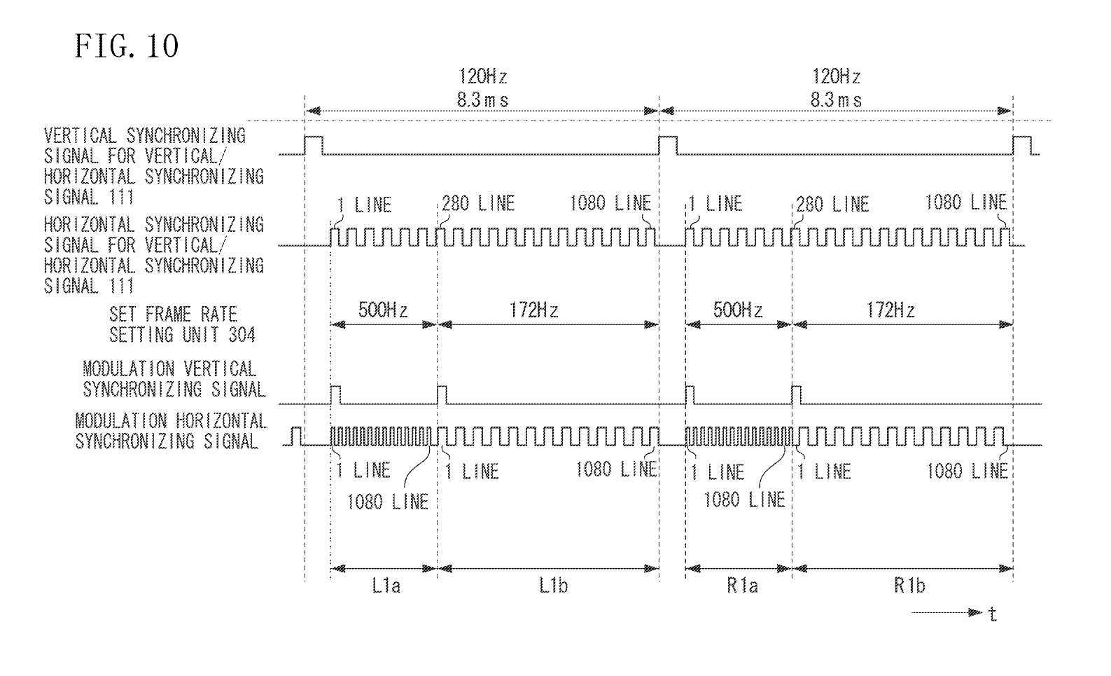

FIG. 10 illustrates the relationship between vertical/horizontal synchronizing signals, frame rate setting values, and timing signals in time. The frame rate setting unit 304 starts counting horizontal synchronizing signals in synchronism with a vertical synchronizing signal of the vertical/horizontal synchronizing signals, and sets a duration from the line 1 to the line 279 of the horizontal synchronizing signal of the vertical/horizontal synchronizing signals, at 500 Hz. Further, the unit sets the horizontal synchronizing signal to be switched to 172 Hz when it reaches the line 280 in a duration until the line 1080. The horizontal synchronizing signal is repeatedly reset and counted in synchronism with the vertical synchronizing signal.

The timing signal includes a modulation vertical synchronizing signal and a modulation horizontal synchronizing signal. The modulation vertical synchronizing signal goes high at the respective lines 1 and 280 of the horizontal synchronizing signal. The modulation horizontal synchronizing signal includes a pulse train of 1080 pulses with oscillations in the duration from the line 1 to the line 279 of the horizontal synchronizing signal at 500 Hz and another pulse train of 1080 pulses with oscillations in the duration from the line 280 to the line 1080 of the horizontal synchronizing signal at 172 Hz. In the duration of the modulation horizontal synchronizing signal at 500 Hz, “L1a/R1a image” is displayed, while in the duration at 172 Hz, “L1b/R1b image” is displayed.

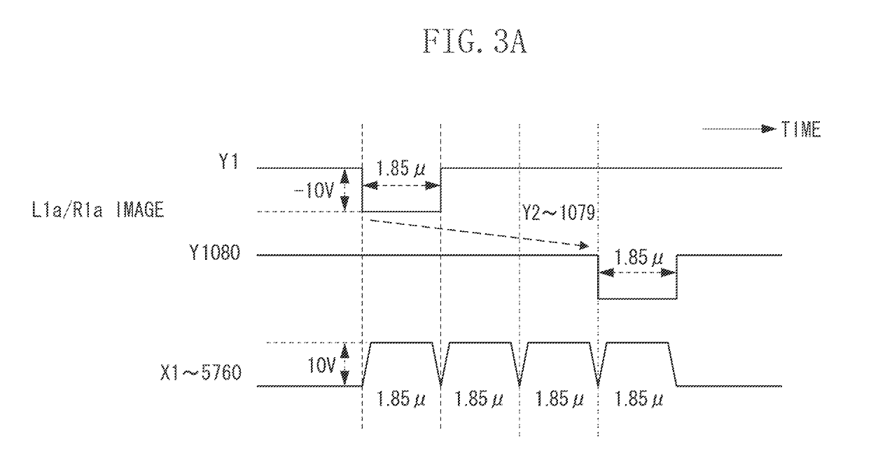

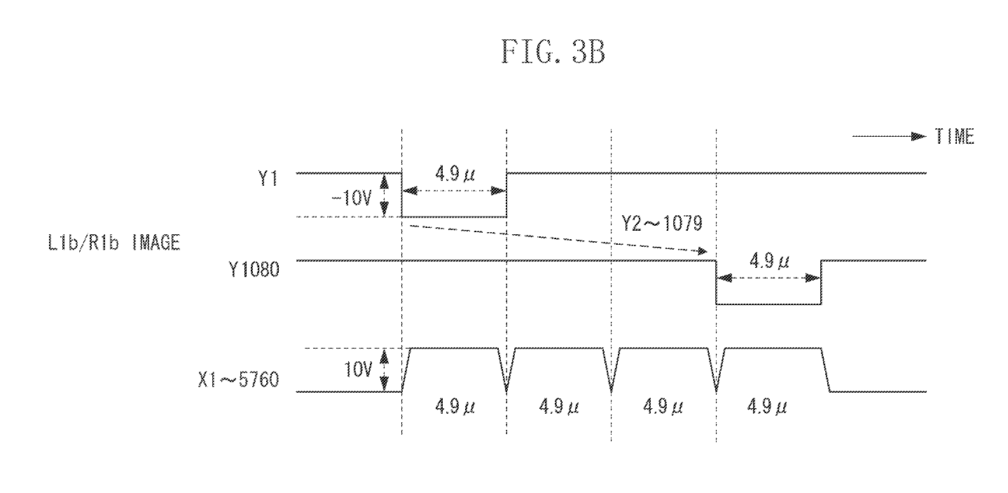

FIG. 3A illustrates waveforms of driving pulses (scanning pulse, signal pulse) output from the X-driver 203 and the Y-driver 202, when to display the L1a/R1a image (rise time of the liquid crystal shutter). The Y-driver 202 sequentially outputs scanning pulses (selective pulse) which are −10V in height and 1.85 μsec in width, to the vertical lines (Y1 to Y1080) (non-selective pulse is 0V). The X-driver 203 parallelly applies signal pulses to the horizontal lines (X1 to X5760) in synchronism with the scanning pulses. The signal pulses are +10V in height and are changed in their width from 0 to 1.85 μsec according to the luminance signal. The pulse range is set in such a manner that the maximum pulse width of 1.85 μsec (display luminance of 75 cd/m²) is obtained, at the luminance level of 100%.

FIG. 3B illustrates waveforms of driving pulses output from the X-driver 203 and the Y-driver 202, when to display L1b/R1b image (in the duration after rising of the liquid crystal shutter). The Y-driver 202 sequentially outputs scanning pulses (selective pulses) that are −10V in height and 4.9 μsec in width, to the vertical lines (Y1 to Y1080) (non-selective pulse is 0V). The X-driver 203 parallelly applies signal pulses to each of the horizontal lines (X1 to X5760) in synchronism with the scanning pulses. The signal pulses are +10V in height and are changed in their width from 0 to 4.9 μsec according to the luminance signal. The pulse range is set in such a manner that the maximum pulse width of 4.9 μsec (display luminance of 300 cd/m²) is obtained, at the luminance level of 100%.

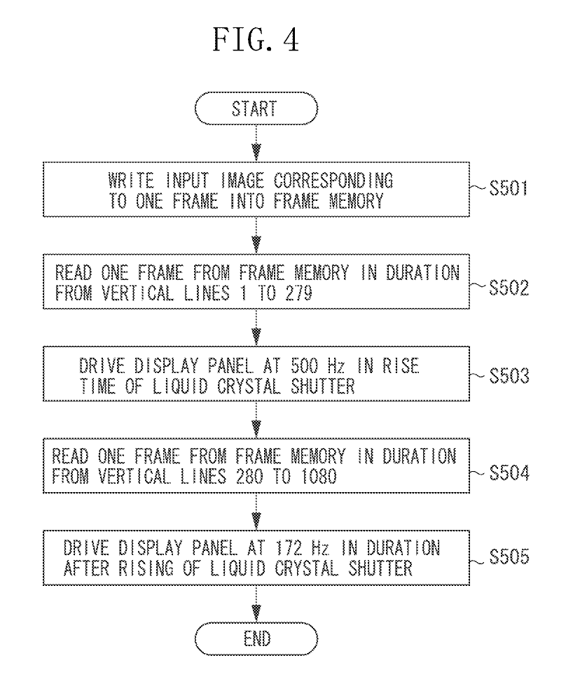

FIG. 4 is a flowchart of a process executed by the MPU 105. In step S501, the MPU 105 writes image signals corresponding to one frame into the frame memory 102 in synchronism with the horizontal synchronizing signal. In step S502, the MPU 105 reads out image signals corresponding to the same frame (L1a or R1a image) from the frame memory 102 at a frame frequency of 500 Hz in the duration from the vertical lines 1 to 279 of the vertical/horizontal synchronizing signal. In step S503, in the rise time of the liquid crystal shutter, the MPU 105 displays one screen at a frame frequency of 500 Hz. In step S504, further, the MPU 105 reads out image signals corresponding to one frame (L1b or R1b image) from the frame memory 102 at a frame frequency 172 Hz in the duration from the vertical lines 280 to 1080 of the vertical/horizontal synchronizing signal. In step S505, in the duration after rising of the liquid crystal shutter, the MPU 105 displays one screen at a frame frequency of 172 Hz. Now, a right-eye image driving at 120 Hz is formed, based on the two displays driving at 500 Hz and 172 Hz. The right-eye image and the left-eye image are displayed in a time-division manner at 120 Hz, thus enabling 3D-image viewing.

When the display luminance at 0120-Hz driving is 100%, the display luminance driving at 500 Hz is 25%, and the display luminance driving at 172 Hz is 75%, as a result of non-uniform division of one frame. The luminance difference is 30% at most between the top and bottom of the screen in response to the liquid crystal shutter. Thus, the display luminance on the side of the rise time (display at 500 Hz) of the shutter is changed in a range from 17.5% to 25%, between the top and bottom of the screen. At 172 Hz display, the luminance distribution does not occur between the top and bottom of the screen. In other words, according to the present invention, the luminance difference between the top and bottom of the screen is 7.5%, thus enabling to reduce the luminance difference to an extent that the difference is recognized.

A second exemplary embodiment will now be described. In the present exemplary embodiment, the luminance of an L1c or R1c image displayed in the rise time of the liquid crystal shutter is changed according to the position of the vertical line, to compensate for a change in the transmittance in the rise time (or decay time) of the liquid crystal shutter. As a result of this, the maximum luminance difference in the screen can be reduced up to 7.5% in the first exemplary embodiment. However, in the present exemplary embodiment, the luminance difference can further be reduced to another 7.5%.

The block diagram of a 3D image viewing system according to the present exemplary embodiment is similar to that of FIG. 2A. However, the video processing circuit 103 of the present exemplary embodiment outputs a resultant luminance signal which has been obtained by adjusting the luminance level of an image signal, to the X-driver 203.

FIG. 2C is a block diagram of the video processing circuit 103. A Look Up Table (LUT) for correction 817 stores luminance correction values in association with vertical lines, in advance. A vertical line counter 815 starts counting the vertical lines in synchronism with the vertical synchronizing signal, and proceeds the counting in synchronism with the horizontal synchronizing signal. A vertical line counter value corresponding to a position of the vertical line is input to the LUT for correction 817. The LUT for correction 817 outputs a correction value corresponding to the vertical line counter value. A multiplication unit 819 multiplies an image signal corresponding to the pixels on each vertical line by a correction value corresponding to each vertical line, and outputs a luminance signal.

The correction value is such a coefficient that increases the luminance, in a reverse direction of a scanning direction, of image signals corresponding to the pixels on each vertical line according to the position of each vertical line, in terms of two frame frequencies of 500 Hz and 172 Hz.

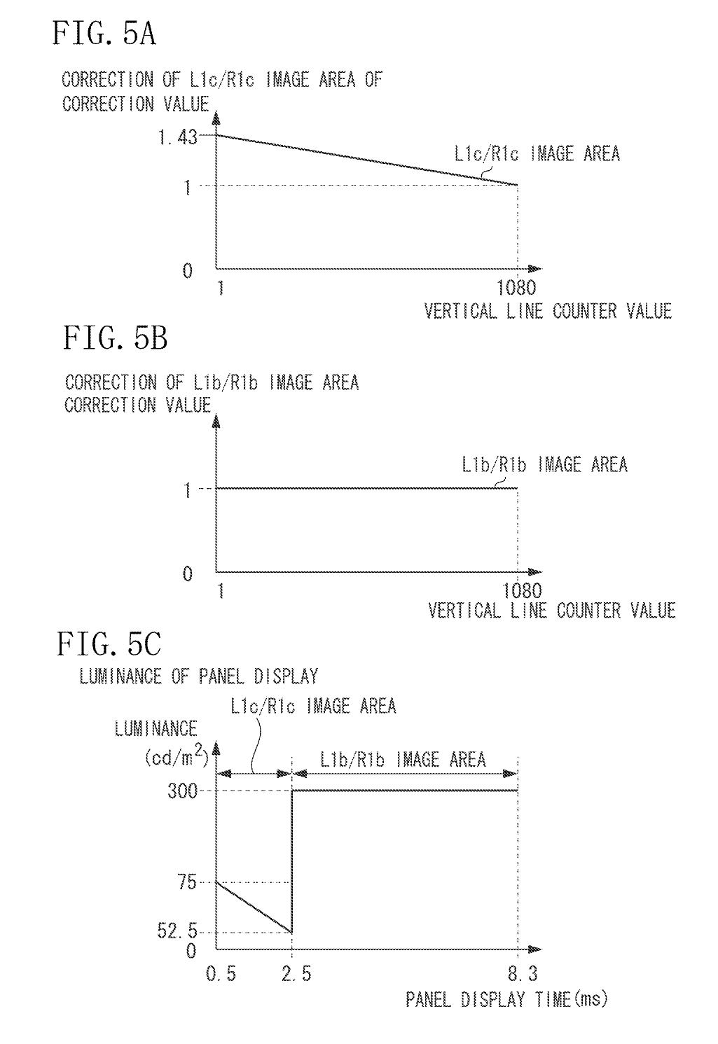

FIG. 5A illustrates the relationship between correction values and vertical line counter values in a L1c/R1c sub-frame (500 Hz). The correction values of the vertical line counter values from 1 to 280 are set to 1.43 to 1.0, while the correction values of the vertical line counter values 280 to 1080 are set to 1.0

FIG. 5B illustrates the relationship between correction values and vertical line counter values in a L1b/R1b sub-frame (172 Hz). The correction values of the vertical line counter values from 1 to 1080 are set to 1.0.

FIG. 5C illustrates the relationship between the display luminance and the display time of the display panel 201, when a luminance signal of maximum luminance level 100% is input to the entire pixels. The correction values are set so that the luminance is constant at 300 cd/m² in the duration from the display time 2.5 ms to 8.3 ms (duration in which the L1b/R1b image is displayed). In addition, the correction values are set so that the luminance is changed in a range from 75 cd/m² to 52.5 cd/m² in the duration from the display time 0.5 ms to 2.5 ms (duration in which the L1c/R1c image is displayed).

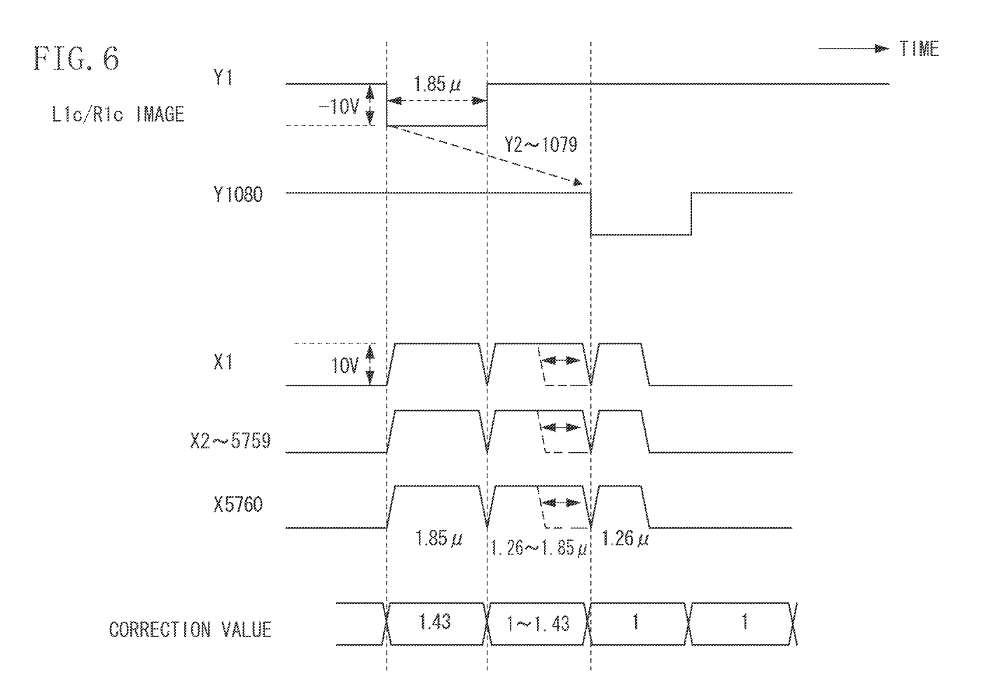

FIG. 6 illustrates waveforms of driving pulses output from the X-driver 203 and the Y-driver 202, in the duration in which the L1c/R1c image is displayed. The driving pulses, in the duration in which the L1b/R1b image is displayed, are similar to those of FIG. 3B. The Y-driver 202 sequentially outputs scanning pulses that are −10V in height and 1.85 μsec in width to the vertical lines (Y1 to Y1080). The X-driver 203 parallelly applies signal pulses to each of the horizontal lines (X1 to X5760) in synchronism with the scanning pulse. The signal pulses are +10V in height, and are changed in width from 0 to 1.8 μsec according to the luminance signal. At the luminance level is 100%, the signal pulses applied to the pixels on the Y1 are set to the maximum width of 1.85 μsec, (correction value is 1.43), to compensate for a decrease, 30%, of the shutter transmittance. The signal pulses applied to the pixels on the Y2 to Y279 cause monotonous reduction of the width of the driving pulses in a range from 1.85 to 1.26 μsec (correction values from 1.43 to 1.0) in a scanning direction, to correspond to the response waveforms of the shutter.

The number of vertical lines, corresponding to correction values to be changed by the monotonous reduction, may be set based on the rise time of the shutter. A change in the correction value is linearly made from Y1 to Y280. However, the change may be made in a curve corresponding to a change in the shutter transmittance of the rise time. The vertical blanking period set in the vertical scanning period may be set based on the rise time of the shutter. In the step where the image signal is calculated with the correction value to generate the luminance signal, the addition of the values maybe achieved, instead of the multiplication.

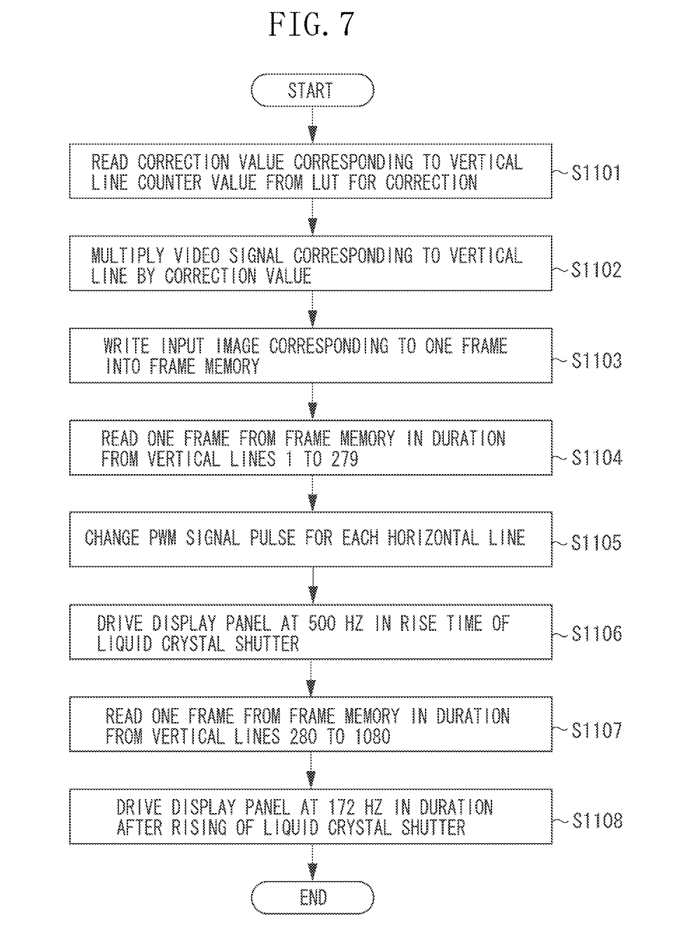

FIG. 7 is a flowchart of a process executed by an MPU 105. In step S1101, the MPU 105 reads out correction values of the vertical lines from the LUT for correction 817 by reference to the vertical line counters. In step S1102, the MPU 105 multiples a corresponding image signal by a correction value corresponding to each vertical line. In step S1103, the MPU 105 writes the corrected image signals corresponding to one frame to a frame memory 102. In step S1104, the MPU 105 reads out image signals corresponding to one frame (L1a or R1a image) from the frame memory 102 at a frame frequency of 500 Hz, in the duration from the vertical lines 1 to 279. In step S1105, the MPU 105 changes the width of the signal pulses for each horizontal line, based on a luminance signal corresponding to the corrected image signal. In step S1106, the MPU 105 drives the liquid crystal shutter at 500 Hz in the rise time. In step S1107, the MPU 105 reads out the same image signals corresponding to one frame (L1b or R1b image) at a frame frequency of 172 Hz from the frame memory 102 in the duration from the vertical lines 280 to 1080. In step S1108, the MPU 105 drives the liquid crystal shutter at 172 Hz in the duration after its rising.

A right-eye image and a left-eye image at a frame rate of 120 Hz are formed by the two driving operations at 400 Hz and 172 Hz, and are displayed alternately, thereby enabling viewing of 3D images.

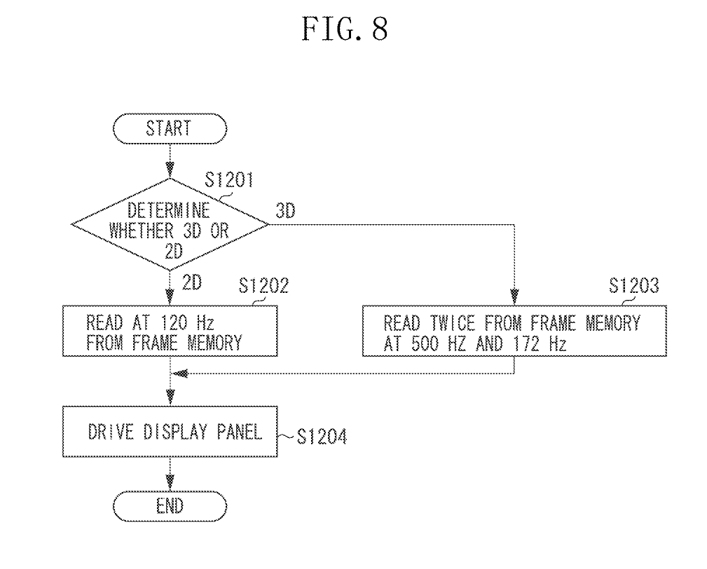

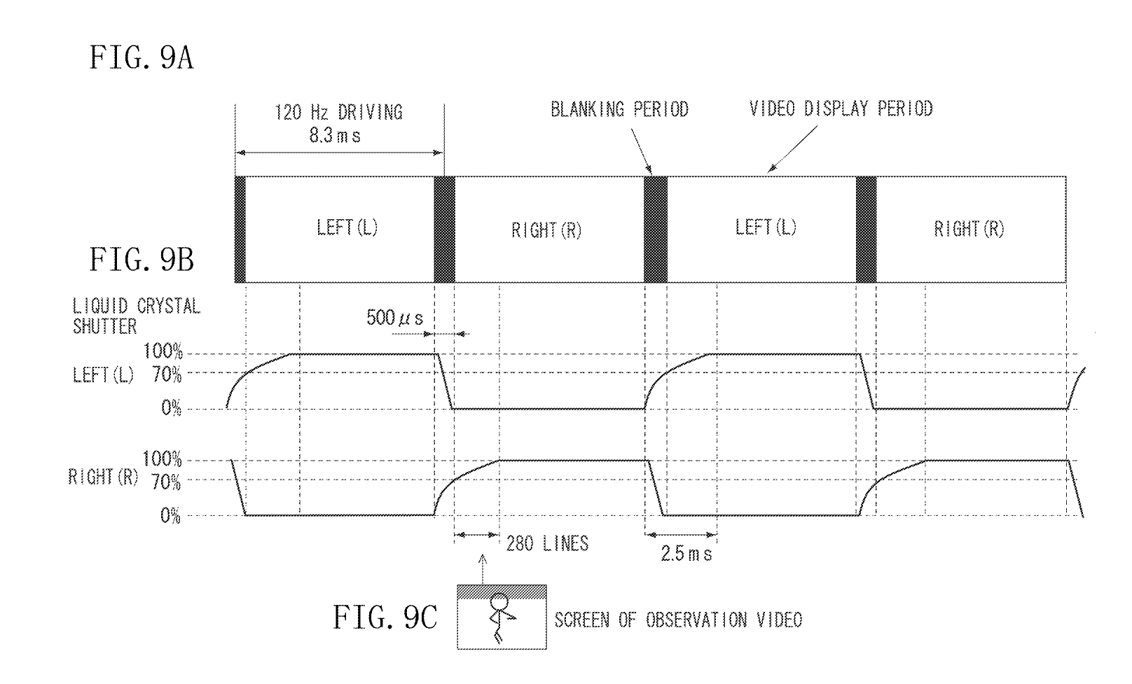

A third exemplary embodiment will now be described. In the present invention, a determination is made as to whether an input image signal is one for 3D image display or for non-3D image display (2D). Based on this determination, a signal process by the timing control circuit 104 can be switched between 3D image display and 2D image display. FIG. 8 is a flowchart illustrating an operation of the image control apparatus 1 according to an input image signal.

In step S1201, A determination is made as to whether an input image signal is for 3D image display or 2D image display. When an input source is digital broadcasting, pre-acquired program information is referred to determine whether a selected program is a 3D program. When the input source is any other source, header information of the video stream is referred to make this determination.

In step S1203, when an input image signal is for 3D image display, signal processing of the timing control circuit 104 is set for 3D image display, in response to an instruction from the MPU 105. In addition, image signals are readout twice from the frame memory 102 at frame rates of 500 Hz (L1a/R1a image) and 172 Hz (L1b/R1b image).

In step S1202, when the input image signal is for 2D image display, a signal process of the timing control circuit 104 is set for 2D image display in response to an instruction from the MPU 105. In addition, an image signal(s) is read out once from the frame memory 102 at a frame rate of 120 Hz.

In step S1204, the display panel is driven by driving pulses set for 3D image display or 2D image display.

Accordingly, when the input image signals are for 3D image display, observation images with equal luminance values can be viewed. On the other hand, when the input image signals are for 2D image display, display images with adjusted luminance values in the entire screen can be viewed.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-251158 filed Nov. 9, 2010, which is hereby incorporated by reference herein in its entirety.

What is claimed is:

1. An apparatus which enables viewing of a 3D image, by controlling an impulse-type image display to alternately display a left-eye image and a right-eye image in a time-division manner, and by alternately opening/closing a left shutter and a right shutter of shutter eyeglasses in synchronism with switch between the left-eye image and the right-eye image, the apparatus comprising:
an input unit configured to input an image signal for displaying an image as the 3D-image; and
a processing unit configured to generate a luminance signal for displaying the right-eye image and the left-eye image from the image signal, and outputs the luminance signal to the image display,
wherein the image display sequentially selects a scanning line to form an image on a screen, in a predetermined frame period, and
wherein each frame for displaying the right-eye image and the left-eye image includes a first sub-frame with a first frame period and a second sub-frame with a second frame period that is longer than the first frame period.

2. The apparatus according to claim 1, further comprises a control unit configured to control the processing unit to display a same image in the first sub-frame and the second sub-frame.

3. The apparatus according to claim 1, wherein
the first frame period is set according to a rise time and a decay time of the shutter.

4. The apparatus according to claim 1, wherein
the frame period of each frame for displaying the right-eye image and the left-eye image includes the first frame period, the second frame period, and a blanking period, and the second frame period is determined corresponding to a resultant period that is obtained by subtracting the first frame period and the blanking period from the frame period.

5. The apparatus according to claim 1, further comprising:
a memory unit which writes the image signal corresponding to at least one frame in synchronism with a horizontal synchronizing signal output from the input unit, and stores the image signal; and
a timing control unit which modulates the horizontal synchronizing signal to correspond to each of the first frame period and the second frame period, wherein
the control unit controls the memory unit and the timing control unit to sequentially read out image signals of the first frame and the second frame from the memory unit and to output the read image signals to the image signal processing unit, in synchronism with the modulated horizontal synchronizing signal.

6. The apparatus according to claim 1, wherein
the control unit corrects the image signal of the first frame, based on a correction value which is set for compensating for a change in transmittance in a rise time or a decay time of the shutter.

7. A method for enabling viewing of a 3D image, by controlling an impulse-type image display to alternately display a right-eye image and a left-eye image in a time-division manner, and by alternately opening/closing a left shutter and a right shutter of shutter eyeglasses in synchronism with switch between the right-eye image and the left-eye image, the method comprising:
inputting an image signal for displaying an image as the 3D image; and
generating a luminance signal for displaying the right-eye image and the left-eye image from the image signal, and outputting the generated luminance signal to the image display, wherein
the image display sequentially selects a scanning line to form an image on a screen, in a predetermined frame period, and
each frame for displaying the right-eye image and the left eye image includes a first sub-frame with a first frame period and a second sub-frame with a second frame period that is longer than the first frame period.

8. The method according to claim 7, further comprises displaying a same image in the first sub-frame and the second sub-frame.

9. The method according to claim 7, wherein
the first frame period is set according to a rise time and a decay time of the shutter.

10. The method according to claim 7, wherein
the frame period of each frame for displaying the right-eye image and the left-eye image includes the first frame period, the second frame period, and a blanking period, and the second frame period is determined corresponding to a resultant period that is obtained by subtracting the first frame period and the blanking period from the frame period.

11. The method according to claim 7, further comprising:
writing the image signal corresponding to at least one frame in synchronism with a horizontal synchronizing signal output from the input unit, and storing the image signal;
modulating the horizontal synchronizing signal to correspond to each of the first frame period and the second frame period; and
sequentially reading out image signals of the first frame and the second frame and outputting the read image signals in synchronism with the modulated horizontal synchronizing signal.

12. The method according to claim 7, further comprising correcting the image signal of the first frame, based on a correction value which is set for compensating for a change in transmittance in a rise time or a decay time of the shutter.
